(19) United States
(12) Patent Application Publication
(10) Pub. No.: US 2020/0198416 A1
(43) Pub. Date: Jun. 25, 2020

(54) METHOD OF TRANSMITTING TIRE PRESSURE INFORMATION AND WIRELESS TIRE PRESSURE MONITOR SYSTEM

(71) Applicant: BCS AUTOMOTIVE INTERFACE SOLUTIONS US LLC, Wilmington, DE (US)

(72) Inventors: XING PING LIN, West Bloomfield, MI (US); MARK BAKER, Brighton, MI (US); SRINIVAS NADIMPALLI, New Hudson, MI (US)

(21) Appl. No.: 16/225,054

(22) Filed: Dec. 19, 2018

(51) Int. Cl. B60C 23/04; G07C 5/00

(52) U.S. Cl. CPC B60C 23/0455; G07C 5/008

(57) ABSTRACT

A wireless tire pressure monitor system configured for transmitting tire pressure information of a tire of a vehicle is described. The wireless tire pressure monitor system comprises a vehicle-based receiver, at least one tire pressure sensor configured to be mounted inside the tire and configured to measure the air pressure within the tire, and a transmitter electronically connected to the tire pressure sensor and configured to transmit a signal comprising the tire pressure information to the vehicle-based receiver. The wireless tire pressure monitor system is configured to transmit the signal in a first transmission mode from the transmitter to the vehicle-based receiver when the tire is rotating, and transmit the signal in a second transmission mode from the transmitter to the vehicle-based receiver when the tire is stationary. Moreover a method of transmitting tire pressure information employing a wireless tire pressure monitor system is described.

### FIELD OF THE DISCLOSURE

Embodiments of the present disclosure relate generally to a method of transmitting tire pressure information employing a wireless tire pressure monitor system. Further embodiments of the present disclosure relate to a wireless tire pressure monitor system configured for transmitting tire pressure information of a tire of a vehicle.

### BACKGROUND

Wireless TPMS are used to monitor the tire pressure of vehicle tires and provide a warning to the driver if the pressure falls below a certain level. The system has at least one tire pressure sensor mounted inside the tire to sense the air pressure of the tire. The sensor also has a radio frequency (RF) transmitter to transmit the information of the pressure sensed to an RF receiver assigned to the vehicle and outside of the tire. The RF receiver will pick up the RF transmission from the sensor and it will process the information. Accordingly, the information is analyzed by the RF receiver or a processing unit associated to the RF receiver.

Due to the multipath and vehicle attenuation, the RF link margin between the tire based pressure sensor and the vehicle based receiver is changing as the tire rotates while the vehicle is driving. At certain rotation angles, the signal of the RF transmitter is too weak for the RF receiver to reliably pick the signal up which results in the RF receiver being unable to correctly process the information so that the tire pressure information is lost. These angles are called “nulls”, since the RF receiver cannot receive the sensor information when the sensors are at these angles.

While the vehicle is in motion, the RF transmitter will transmit signals periodically, e.g. every minute. A typical transmission message consists of multiple frames, each comprising the tire pressure information and temperature information as well as the sensor ID. Hence, it can be verified which tire sensor transmits the respective information. Also, the transmission of each frame takes a certain amount of time. The shorter the time frame, the less likely it will collide with a null angle. Thus, in a typical wireless TPMS application the transmission data rate is relatively high, usually around 10 kbits/s.

Wireless TPMS are also a useful tool to assist the user when the tires are low on pressure and need to be inflated. In this case, the wireless TPMS monitors the inflation of the tires and the vehicle provides feedback, like sounding a horn or flashing lights, to inform the user when a predetermined pressure is reached. However, if the RF transmitter is located at a “null” angle, the RF receiver will not receive the signal of the RF transmitter and thus will not give proper feedback to the user. Since the vehicle is stationary and the tires are not moving during any inflating operation, the RF receiver is not enabled to pick up the signal eventually since the relative orientation of the tire pressure sensor with respect to the tire will not change. As a result, the user runs the risk of increasing the pressure to a higher level than intended.

Accordingly, there is a need for a method of transmitting tire pressure information as well as for a wireless tire pressure monitor system that resolve these issues.

### SUMMARY

Embodiments of the present disclosure provide a method of transmitting tire pressure information employing a wireless tire pressure monitor system comprising a vehicle-based receiver, at least one tire pressure sensor mounted inside a tire and a transmitter, comprising the following steps:
Using a first transmission mode to transmit a first signal from the transmitter to the receiver when the tire is rotating, wherein the first signal comprises the tire pressure information, and
Using a second transmission mode to transmit a second signal from the transmitter to the receiver when the tire is stationary, wherein the second signal comprises the tire pressure information.

Embodiments of the disclosure also provide a wireless tire pressure monitor system configured for transmitting tire pressure information of a tire of a vehicle. The wireless tire pressure monitor system comprises a vehicle-based receiver, at least one tire pressure sensor configured to be mounted inside the tire and configured to measure the air pressure within the tire, and a transmitter electronically connected to the tire pressure sensor and configured to transmit a signal comprising the tire pressure information to the vehicle-based receiver. The wireless tire pressure monitor system is configured to transmit the signal in a first transmission mode from the transmitter to the vehicle-based receiver when the tire is rotating, and transmit the signal in a second transmission mode from the transmitter to the vehicle-based receiver when the tire is stationary.

By using different transmission modes when the vehicle is stationary, and thus the tires of the vehicle do not rotate, and when the vehicle is in motion, and thus the tires of the vehicle rotate, the transmission modes can be adapted to the specific requirements and circumstances influencing the transmission characteristics. In this way, the first transmission mode can be optimized for reliably transmitting the first signal from the transmitter to the receiver when the vehicle is in motion. The second transmission mode can be optimized for reliably transmitting the second signal from the transmitter to the receiver when the vehicle is stationary. In this way, the transmitted tire pressure information can be reliably received by the receiver when the vehicle is in motion as well as when the vehicle is stationary irrespective of the relative position of the tire pressure sensor with respect to the tire. Particularly, no “null” angle occurs in the second transmission mode. As a result, the TPMS is reliably updated at all times so risks can be minimized, like the inflation of a tire above a certain pressure level.

In the same manner, the vehicle based receiver will set the proper receiving mode accordingly to match these modes in order to establish the optimal protocol for optimal reception in each mode.

The status, i.e. whether the tire is stationary or in motion, can be determined by the vehicle speed information, e.g. provided by an on-board computer and/or a motion sensor, e.g. a g-force sensor, associated with the respective tire.

In an embodiment of the disclosure, the vehicle based receiver will set the first optimal receiving mode (best reception) to match the first transmission mode, based on the vehicle bus speed information. In this manner, the first optimal communication protocol in a typical tire pressure monitor driving mode is established.

In another embodiment of the disclosure, the vehicle based receiver will set the second optimal receiving mode (best reception) to match the second transmission mode, based on the vehicle bus “0” speed information, i.e. when the vehicle is stationary. In this manner, the second optimal communication protocol in a stationary application, such as tire fill application, is established.

In this way, the transmission modes and the reception modes can be adapted to the specific requirements and circumstances influencing the transmission characteristics for the best reception accordingly.

According to one aspect of the disclosure, the data rate in the second transmission mode is lower than the data rate in the first transmission mode. In the first transmission mode the transmitter transmission frame lasts over a range of rotation angles of the respective tire. The shorter the transmission frame, the less likely null angles, i.e. angles where the signal is not reliably received, will fall into the transmission frame. It is therefore desired to have short transmission frame times, in particular when the vehicle is driving at high speed. To transmit the same number of bits, the short transmission frame time results in a high data rate. At the stationary condition, since the tire is not rotating and the transmission will occur at a single angle position of the transmitter, the transmission frame time is not critical. On the other hand, the receiver sensitivity is directly associated with the data rate. The higher the data rate, the lower the sensitivity. Thus, the lower data rate in the second transmission mode leads to an increased sensitivity of the receiver which in turn leads to the receiver picking up weaker signals more reliably. In this way, the transmitted tire pressure information can be reliably received by the receiver when the vehicle is stationary, even though the transmitter or rather the tire pressure sensor is positioned at an angle that corresponds to a null angle for the first transmission mode.

In general, the lower the data rate is, the higher the receiver sensitivity would be. However, there are some other hardware limitations as well as length of the communication time to consider. If the rate is too slow, the system may not be able to follow the added pressure change rate.

In an embodiment of the disclosure, the data rate in the second transmission mode is lower than 5 kbits/s, preferably lower than 3 kbits/s, in particular lower than 2 kbits/s. This data rate has the advantage that it is low enough and the respective sensitivity of the receiver high enough to pick up the signal even when the transmitter is at a location which is considered to be a null position for the first transmission mode. In other words, the signal can be reliably transmitted and respectively received at all angle positions of the transmitter, i.e. there are no null angles or null positions.

In this way, the null angles can be reduced or eventually eliminated for many applications.

In a further embodiment of the disclosure, the data rate in the second transmission mode is in the range of 0.5 kbits/s and 2.5 kbits/s, preferably in the range of 1.0 kbits/s and 2.0 kbits/s, in particular 1.5 kbits/s. In this range the data rate is so low and the respective sensitivity of the receiver is so high that the signal can be reliably received at all angle positions of the transmitter, i.e. there are no null angles or null positions.

In the first transmission mode, the data rate may be in the range of 4 kbits/s to 15 kbits/s, in particular 8 kbits/s to 11 kbits/s, preferably 9.6 kbits/s. In other words, the data rate may be higher than 4 kbits/s in the first transmission mode, in particular higher than 8 kbits/s, preferably higher than 9 kbits/s.

According to another embodiment of the disclosure, the first signal and the second signal are modulated differently. In this way, the first transmission mode and the second transmission mode each can be optimized for the receiver to reliably receive the first signal or rather the second signal, respectively.

In other words, different modulations can be applied for different application conditions. Thus, best chance of receiving the sensor information is ensured.

According to another aspect of the disclosure, the second signal comprises at least one of an amplitude modulation (AM) and an amplitude-shift keying (ASK) modulation for its lower bandwidth requirement and sensitivity nature. When the vehicle is in motion, especially when driving at high speed, the transmitter signal can fluctuate at the receiver input. AM or ASK modulation are more sensitive to the amplitude change and thus are not suitable for the high speed driving TPMS applications. But low data rate AM or low data rate ASK modulation can be used to increase the reliability of the reception when the vehicle is stationary as the receiver bandwidth can be narrower.

Other modulations may also be used, in particular if the receiver bandwidth is largely not limited by the modulation.

The first signal may comprise at least one of a frequency shift key (FSK) modulation and a phase modulation (PM). During high-speed driving, the sensor signal at the input of the receiver may fluctuate so that FSK modulation or rather PM are good for tire pressure monitoring during the driving.

In a certain embodiment of the disclosure, the signal is a radio frequency signal, in particular in the range of 3 MHz to 300 GHz.

According to one aspect of the disclosure, the vehicle-based receiver is a radio frequency (RF) receiver and the transmitter is a radio frequency (RF) transmitter.

Radio frequency (RF) is particularly suited to be used for transmitting wireless signals.

Any individual feature of any of the embodiments disclosed above may be part of any of the embodiments disclosed above, thus forming a further embodiment of the disclosure. In other words, any or all of the individual features disclosed above can be combined in a further embodiment of the disclosure.

Generally, the vehicle-based receiver will adjust its receiving mode based on the vehicle speed to match the sensor transmission mode. Accordingly, best receiving and transmission modes are ensures as they match with each other. These vehicle speed dependent optimal communication protocols achieve the best tire pressure monitor system.

In fact, the respective features apply to the system as well as the method in equivalent manner.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a stationary vehicle with an embodiment of a wireless tire pressure monitor system according to the present disclosure in a side view; and

FIG. 2 schematically shows the vehicle of FIG. 1 in motion.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

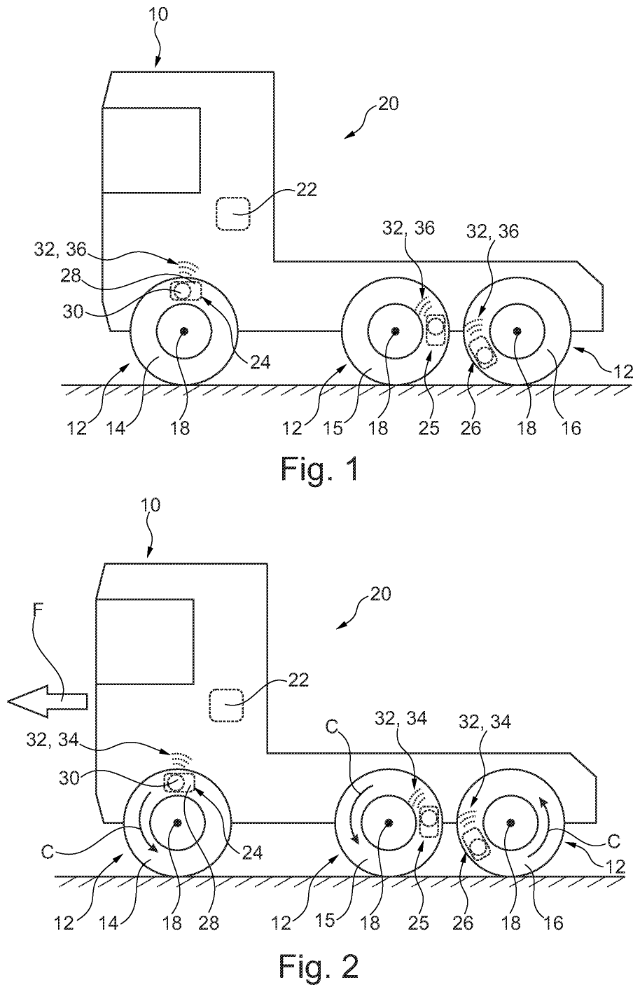

FIG. 1 schematically shows a vehicle 10 established by a large truck. In the shown embodiment, the vehicle 10 has six wheels 12 of which only three are visible in FIG. 1 since the vehicle 10 is shown in a side view.

In an alternative embodiment, the vehicle 10 may be any kind of vehicle with any number of wheels 12, for instance four or rather eight.

Each wheel 12 has a pneumatic tire 14, 15, 16 that is typically inflated by pressurized air. Of course, the pneumatic tires 14, 15, 16 can be inflated by any kind of gaseous fluid alternatively.

Further, each wheel 12 is rotatably suspended around an axis 18, in particular in pairs so that each axis 18 is assigned to two wheels 12.

Moreover, the vehicle 10 has a wireless tire pressure monitor system 20 that comprises a vehicle-based receiver 22 as well as at least one sensor unit 24, 25, 26 for each tire 14, 15, 16.

The vehicle-based receiver 22 is an RF receiver.

The vehicle-based receiver 22 may be powered by an automobile battery of the vehicle 10 and is electronically connected to an on-board computer of the vehicle 10, namely a processing device.

Each sensor unit 24, 25, 26 comprises a tire pressure sensor 28 and a transmitter 30, wherein the tire pressure sensor 28 and the transmitter 30 are electronically connected with each other.

Further, each sensor unit 24, 25, 26 comprises a battery forming the power supply of the sensor unit 24, 25, 26.

Alternatively, the sensor unit 24, 25, 26 is powered wirelessly via the vehicle-based receiver 22 being a transceiver. Accordingly, the vehicle-based receiver 22 may send out a request signal which activates the sensor unit(s) 24, 25, 26 to sense the pressure and to transmit the pressure information obtained.

A sensor unit 24, 25, 26 is located within each tire 14, 15, 16 or rather at least assigned thereto enabled to gather pressure information.

The tire pressure sensor 28 is configured to measure the air pressure within the respective tire 14, 15, 16 the tire pressure sensor 28 is located in or rather assigned to.

The transmitter 30 is an RF transmitter. Thus, the transmitter 30 is enabled to communicate with the vehicle-based receiver 22 being an RF (trans-)receiver.

The transmitter 30 is configured to transmit a signal 32 comprising at least the tire pressure information determined by the respective tire pressure sensor 28 to the receiver 22, which in turn is configured to receive the signal transmitted by the transmitter 30.

Besides the respective tire pressure information, temperature information and/or a sensor ID may be transmitted so that the vehicle-based receiver 22 receiving the signals is enabled to assign the respective information received to the tires 14, 15, 16.

In FIG. 1 the vehicle 10 is stationary and thus the wheels 12 are stationary, i.e. they do not rotate around their respective axis 18. For instance, the vehicle 10 is shown in a tire inflating mode.

FIG. 2 schematically shows the vehicle 10 moving in forward direction F with the wheels 12 rotating in circumferential direction C.

Obviously, the wheels 12 would rotate in opposite direction if the vehicle 10 reverses, i.e. the vehicle 10 moves backwards in opposite direction to forward direction F.

When the wheels 12 rotate, the tires 14, 15, 16 as well as the sensor units 24, 25, 26 rotate along with the wheels 12 in the respective direction.

Due to structural conditions as well as due to the design of the vehicle 10 and the wireless tire pressure monitor system 20, there are so-called null positions in which signals 32 between the transmitters 30 and the receiver 22 are significantly attenuated when the respective transmitter 30 is located in such a null position.

In the embodiment shown, these null positions are located at the 12 o'clock (0° or 360°), the 3 o'clock (90°), the 6 o'clock (180°) and the 9 o'clock (270°) positions of the tires 14, 15, 16. These positions are only chosen for illustrative purposes as they may be different in real application. For instance, a null position may also be located at the 7 o'clock position (210°).

In the shown embodiment, the sensor unit 24 located at the 12 o'clock position and the sensor unit 25 located at the 3 o'clock position are in a null position where the signal of their respective transmitter 30 is attenuated to a significant degree.

The sensor unit 26 located at the 8 o'clock (240°) position on the other hand, is not in a null position and thus the signal between the respective transmitter 30 and the receiver 22 is less attenuated.

Of course, in an alternative embodiment, each wheel 12 may have any number of null positions located in any kind of positions.

The wireless tire pressure monitor system 20 has a first and a second transmission mode 34, 36.

Accordingly, the wireless tire pressure monitor system 20 is configured to use the first transmission mode 34 to transmit the tire pressure information in form of a first signal 32 when the vehicle 10 is in motion (see FIG. 2), and the wireless tire pressure monitor system 20 is configured to use the second transmission mode 36 to transmit the tire pressure information in form of a second signal 32 when the vehicle 10 is stationary (see FIG. 1).

The information of whether or not the vehicle 10 is in motion, can be provided by the on-board computer and/or motion sensors.

In a further embodiment, the wireless tire pressure monitor system 20 could comprise an individual rotation sensor for each wheel 12 configured to detect the rotation of the respective wheel 12 and/or one or more g-force sensors and/or vibration sensors to determine if the vehicle 10 or the respective wheel 12 is stationary or not.

Moreover, the wireless tire pressure monitor system 20 may comprise a geolocation system so that a movement can be detected appropriately. Alternatively, the wireless tire pressure monitor system 20 uses the geolocation system of the vehicle 10, for instance the one of a navigation system.

In the first transmission mode 34 signals 32 are transmitted using a data rate of 9.6 kbits/s. The signals 32 in the first transmission mode 34 are also called first signals.

Of course, in a different embodiment any suitable data rate could be used in the first transmission mode 34, especially data rates in the range of 8.0 kbits/s and 12.0 kbits/s, preferably in the range of 9.0 kbits/s and 11.0 kbits/s, in particular in the range of 9.5 kbits/s and 10.0 kbits/s.

In a further embodiment, the first transmission mode 34 employs frequency-shift keying (FSK) modulation and/or phase modulation (PM).

In the first transmission mode 34 a typical 9.6 kbits/s FSK receiver sensitivity is around −108 dBm. For a large vehicle 10 and high attenuation of the RF transmitter 30 from the large tire 14, the RF link between the transmitter 30 inside the tire 14 and the receiver 22, in particular the receiver 22 inside the cabin, is poor and there are multiple angles of the tire 14 rotation could be classified as nulls. This means the 9.6 kbits/s FSK receiver 22 is not able to reliably receive the signal 32 of the transmitter 30 when the transmitter 30 is in these angle positions.

When the vehicle 10 is in motion, the wireless tire pressure monitor system 20 works fine, i.e. the tire pressure information is reliably transmitted from the transmitters 30 to the receiver 22 and received by the receiver 22. The reason for this is that since the transmitter 30 transmits many frames, the sensor 28 information will be passed on to the receiver 22 as long as some of the transmission frames occur outside the null angles during the rotation of the tire 14, 15, 16.

In other words, the information can be transmitted and received in a reliable manner due to the high data rate and the respective short time required for transmitting the respective information.

However, when the vehicle 10 is stationary, like for tire fill assistant applications, namely inflating operation, no matter how many transmission frames the transmitter 30 sends out, none of the information will be received by the receiver 22 if the transmitter 30 is in a null position.

To improve the sensitivity of the receiver 22, when the vehicle 10 is stationary, the second transmission mode 36 is used.

In the second transmission mode 36 signals 32 are transmitted using a data rate of 1.5 kbits/s which is much lower than the data rate of the first transmission mode 34 of 9.6 kbits/s. The signals 32 transmitted in the second transmission mode 36 are also called second signals.

In a different embodiment, any data rate lower than the data rate of the first transmission mode 34 could be used in the second transmission mode 36, especially data rates in the range of 0.5 kbits/s and 2.5 kbits/s, preferably in the range of 1.0 kbits/s and 2.0 kbits/s, in particular 1.5 kbits/s.

In a further embodiment, the data rate in the second transmission mode 36 is lower than 5 kbits/s, preferably lower than 3 kbits/s, in particular lower than 2 kbits/s.

In another embodiment, the second transmission mode 36 employs amplitude modulation (AM) and/or amplitude-shift keying (ASK) modulation and/or other kinds of modulation.

By using a 1.5 kbits/s ASK transmission in the second transmission mode 36, the receiver sensitivity could be improved by 6 dBm to −114 dBm under test conditions.

Alternatively or additionally to the data rate change between the stationary and the driving mode, different modulation schemes can be applied for the first and the second transmission mode 34, 36.

Frequency-shift keying (FSK) modulation and phase modulation (PM) detection are independent of the amplitude. During the high-speed drive, the signal 32 of the transmitter 30 at the input of the receiver 22 can fluctuate, so FSK and PM modulation are good for wireless tire pressure monitor applications while the vehicle 10 is in motion.

Amplitude-shift keying (ASK) modulation or amplitude modulation (AM) are more sensitive to the amplitude change, so it is not suitable for the high-speed driving wireless tire pressure monitor applications. However, low data rate ASK is a good option for stationary tire 14, 15, 16 fill assistant and pressure loss warning applications as it can have a narrower receiver bandwidth when compared to the FSK which has a wider bandwidth to cover the extra frequency deviation between the bits.

However, using FSK in stationary mode is not excluded, i.e. FSK can also be applied in stationary mode. In certain applications, for example where other factors like oscillator frequency tolerance dominate the bandwidth requirement, FSK may work as well with its own advantage such as being immune to certain spike noise.

In this way, by applying a comparably slow data rate in the second transmission mode 36 a high receiver sensitivity of the vehicle-based receiver 22 is achieved which results in a reduced range of null angles or eliminates the nulls entirely.

Thus, the wireless tire pressure monitor system 20 optimizes the RF system parameters for an optimal RF link at stationary condition, which makes the wireless tire pressure monitor system 20 particularly well suited for tire fill assistant applications and further allows the wireless tire pressure monitor system 20 to reliably detect a pressure loss during parking of the vehicle 10.

This improvement can occur either at the transmitter 30 side or the receiver 22 side or both.

In a further embodiment, the wireless tire pressure monitor system 20 is configured to adjust the optimal receiving mode based on the vehicle 10 speed condition to match the optimal transmission mode of the transmitter 30. These vehicle speed dependent communication protocols provide a wireless tire pressure monitor system 20 that is highly reliable and robust.

A further advantage of this embodiment is, that an improved transmission is achieved through increased sensitivity instead of increased transmission power. Thus, the method described above as well as the wireless tire pressure monitor system 20 employing this method are more energy efficient.

1. A method of transmitting tire pressure information employing a wireless tire pressure monitor system comprising a vehicle-based receiver, at least one tire pressure sensor mounted inside a tire and a transmitter, comprising the following steps:
Using a first transmission mode to transmit a first signal from the transmitter to the receiver when the tire is rotating, wherein the first signal comprises the tire pressure information, and
Using a second transmission mode to transmit a second signal from the transmitter to the receiver when the tire is stationary, wherein the second signal comprises the tire pressure information.

2. The method of claim 1, wherein the data rate in the second transmission mode is lower than the data rate in the first transmission mode.

3. The method of claim 1, wherein the data rate in the second transmission mode is lower than 5 kbits/s.

4. The method of claim 1, wherein the data rate in the second transmission mode is in the range of 0.5 kbits/s and 2.5 kbits/s.

5. The method of claim 1, wherein the first signal and the second signal are modulated differently.

6. The method of claim 1, wherein the second signal comprises at least one of an amplitude modulation (AM) and an amplitude-shift keying (ASK) modulation.

7. The method of claim 1, wherein the signal is a radio frequency signal.

8. A wireless tire pressure monitor system configured for transmitting tire pressure information of a tire of a vehicle, wherein the wireless tire pressure monitor system comprises
a vehicle-based receiver,
at least one tire pressure sensor configured to be mounted inside the tire and configured to measure the air pressure within the tire, and
a transmitter electronically connected to the tire pressure sensor and configured to transmit a signal comprising the tire pressure information to the vehicle-based receiver,
wherein the wireless tire pressure monitor system is configured to transmit the signal in a first transmission mode from the transmitter to the vehicle-based receiver when the tire is rotating, and
transmit the signal in a second transmission mode from the transmitter to the vehicle-based receiver when the tire is stationary.

9. The wireless tire pressure monitor system of claim 8, wherein the data rate in the second transmission mode is lower than the data rate in the first transmission mode.

10. The wireless tire pressure monitor system of claim 8, wherein the data rate of the second transmission mode is lower than 5 kbits/s.

11. The wireless tire pressure monitor system of claim 8, wherein the data rate of the second transmission mode is in the range of 0.5 kbits/s and 2.5 kbits/s.

12. The wireless tire pressure monitor system of claim 8, wherein the signal in the second transmission mode is modulated according to at least one of amplitude modulation (AM) and amplitude-shift keying (ASK) modulation.

13. The wireless tire pressure monitor system of claim 8, wherein the vehicle-based receiver is a radio frequency receiver and the transmitter is a radio frequency transmitter.
